(19) United States
(12) Patent Application Publication
(10) Pub. No.: US 2015/0065051 A1
(43) Pub. Date: Mar. 5, 2015

(54) TWO-WAY COMMUNICATION SYSTEM

(71) Applicant: ALPS ELECTRIC CO., LTD., Tokyo (JP)

(72) Inventor: Akira Miyazawa, Miyagi-Ken (JP)

(73) Assignee: ALPS ELECTRIC CO., LTD.

(21) Appl. No.: 14/473,196

(22) Filed: Aug. 29, 2014

(30) Foreign Application Priority Data
Sep. 2, 2013 (JP) 2013-181258

(51) Int. Cl. H04W 4/08; H04W 4/00

(52) U.S. Cl. CPC H04W 4/08; H04W 4/008
USPC 455/41.2

(57) ABSTRACT

A two-way communication system includes an in-vehicle unit and a plurality of portable units. The in-vehicle unit includes a plurality of in-vehicle communication units, and an in-vehicle control unit. The in-vehicle unit or the portable units each include a received electric field strength detection unit that detects received electric field strength, and a received electric field strength determination unit that performs determination, based on the received electric field strength. In a case where the received electric field strength is less than a predetermined value, the plural in-vehicle communication units and one of the portable units are communication-connected to each other, and in a case where the received electric field strength is greater than or equal to the predetermined value, the plural in-vehicle communication units and the plural portable units are communication-connected to each other on a one-to-one basis.

### CLAIM OF PRIORITY

This application claims benefit of priority to Japanese Patent Application No. 2013-181258 filed on Sep. 2, 2013, which is hereby incorporated by reference in its entirety.

### BACKGROUND

1. Field of the Disclosure

The present disclosure relates to a two-way communication system, and, in particular, relates to a two-way communication system including a plurality of in-vehicle communication units and a plurality of portable units.

2. Description of the Related Art

Recently, a two-way communication system that includes an in-vehicle unit installed in a vehicle and a portable unit capable of performing two-way communication with the in-vehicle unit, and is capable of performing an operation on the vehicle (hereinafter, abbreviated to a vehicle operation) using the two-way communication between the in-vehicle unit and the portable unit has been put to practical use.

In addition, recently, such a two-way communication system has been further developed, and a two-way communication system to which a function is added has been desired, examples of the function including stabilizing communication using a space diversity effect while causing a plurality of in-vehicle communication units and one portable unit to be communication-connected to each other, and simultaneously performing a plurality of vehicle operations while causing a plurality of in-vehicle communication units and a plurality of portable units to be communication-connected to each other on a one-to-one basis. As a technique relating to such a two-way communication system, an in-vehicle device according to Japanese Unexamined Patent Application Publication No. 2008-42577, and so forth have been proposed. In Japanese Unexamined Patent Application Publication No. 2008-42577, a method for communication connections in two-way communication between one in-vehicle device 200 (in-vehicle unit) and a plurality of mobile phones M (portable units) is illustrated. FIG. 8 is an explanatory diagram illustrating the in-vehicle device 200 and the mobile phones M according to Japanese Unexamined Patent Application Publication No. 2008-42577.

As illustrated in FIG. 8, the in-vehicle device 200 is installed in a vehicle V. In addition, the in-vehicle device 200 includes a Bluetooth (registered trademark) communication unit 201 (in-vehicle communication unit), and a directional antenna 202. The mobile phones M each include a Bluetooth communication unit 203. The Bluetooth communication unit 201 and the Bluetooth communication units 203 are communication devices compatible with a short distance wireless communication standard called Bluetooth (registered trademark). The directional antenna 202 is set so the communication area of the Bluetooth communication unit 201 covers the driver seat area of the vehicle V.

By comparing received signal strength (received electric field strength) in communication between the in-vehicle device 200 and the mobile phones M with one another, the in-vehicle device 200 automatically selects one of the mobile phones M, considered to be most likely to be a driver's mobile phone M, from among the plural mobile phones M. In addition, the in-vehicle device 200 automatically performs a communication connection with the selected mobile phones M. In this way, the in-vehicle device 200 performs a communication connection by automatically selecting one mobile phone M from among the plural mobile phones M, and performs two-way communication with the communication-connected mobile phone M.

In addition, while Japanese Unexamined Patent Application Publication No. 2008-42577 is a technique relating to the two-way communication between the one in-vehicle communication unit and the plural portable units, it becomes possible to stabilize communication using the space diversity effect, by utilizing a plurality of such in-vehicle communication units and causing the in-vehicle communication units to be communication-connected to one portable unit out of the plural portable units. In addition, by utilizing a plurality of such in-vehicle communication units and causing the in-vehicle communication units to be communication-connected to a plurality of portable units on a one-to-one basis, it becomes possible to simultaneously perform a plurality of vehicle operations.

However, while, in such a method for a communication connection as illustrated in Japanese Unexamined Patent Application Publication No. 2008-42577, it is possible for the in-vehicle communication unit to select one portable unit from among the plural portable units and perform a communication connection therewith, the communication connection between the in-vehicle communication unit and the portable unit is not switched after the communication connection is established. Therefore, in order to stabilize communication using the space diversity effect while causing the plural in-vehicle communication units and one of the portable units to be communication-connected to each other and to simultaneously perform a plurality of vehicle operations while causing the plural in-vehicle communication units and the plural portable units to be communication-connected to each other on a one-to-one basis, the plural in-vehicle communication units corresponding to respective intended purposes become necessary. For example, in a case where two in-vehicle communication units are used in order to obtain the space diversity effect and two in-vehicle communication units are used in order to simultaneously perform the plural vehicle operations, four in-vehicle communication units become necessary. As a result, there is a problem that the number of in-vehicle communication units increases and the configuration of a system becomes complex.

### SUMMARY

A two-way communication system according to an aspect of the invention includes an in-vehicle unit installed in a vehicle, and a plurality of portable units capable of performing two-way communication with the in-vehicle unit. The in-vehicle unit includes a plurality of in-vehicle communication units configured to perform two-way communication with the portable units, and an in-vehicle control unit configured to control communication connections between the in-vehicle communication units and the portable units. The in-vehicle unit or the portable units each include a received electric field strength detection unit configured to detect received electric field strength in the two-way communication between the in-vehicle unit and the portable units, and a received electric field strength determination unit configured to perform determination, based on the received electric field strength. In a case where the received electric field strength is less than a predetermined value, the plural in-vehicle communication units and one of the portable units are communication-connected to each other, and in a case where the received electric field strength is greater than or equal to the predetermined value, the plural in-vehicle communication units and the plural portable units are communication-connected to each other on a one-to-one basis.

The two-way communication system of this configuration includes the in-vehicle unit installed in the vehicle, and the plural portable units capable of performing two-way communication with the in-vehicle unit. In addition, the in-vehicle unit includes the plural in-vehicle communication units configured to perform two-way communication with the portable units, and the in-vehicle control unit configured to control communication connections between the in-vehicle communication units and the portable units. Therefore, in the two-way communication system, it is possible to perform selective communication connections between the plural in-vehicle communication units and the plural portable units. In addition, it is possible to stabilize communication using the space diversity effect while causing the plural in-vehicle communication units and one of the portable units to be communication-connected to each other, and it is possible to simultaneously perform a plurality of vehicle operations while causing the plural in-vehicle communication units and the plural portable units to be communication-connected to each other on a one-to-one basis.

Furthermore, in the two-way communication system of this configuration, the in-vehicle unit or the portable units each include the received electric field strength detection unit configured to detect received electric field strength in the two-way communication between the in-vehicle unit and the portable units, and the received electric field strength determination unit configured to perform determination, based on the received electric field strength. In addition, based on the received electric field strength, communication connections between the plural in-vehicle communication units and the plural portable units are switched, and the plural in-vehicle communication units and one of the portable units are communication-connected to each other, or the plural in-vehicle communication units and the plural portable units are communication-connected to each other on a one-to-one basis. Therefore, it is possible to cause the in-vehicle communication units for obtaining the space diversity effect to double as the in-vehicle communication units for performing the two-way communication with the plural portable units on a one-to-one basis. As a result, it is possible to reduce the number of the in-vehicle communication units and to simplify the configuration of the system.

### BRIEF DESCRIPTION OF THE DRAWINGS

FIGS. 1A and 1B are configuration diagrams illustrating a configuration of a two-way communication system according to a first embodiment of the present invention;

FIG. 2 is an explanatory diagram illustrating an example of use of the two-way communication system illustrated in FIGS. 1A and 1B;

FIG. 3 is a flowchart illustrating a procedure of a communication connection according to the first embodiment of the present invention;

FIGS. 4A and 4B are first explanatory diagrams illustrating specific examples of communication connections according to the first embodiment of the present invention;

FIGS. 5A and 5B are second explanatory diagrams illustrating specific examples of communication connections according to the first embodiment of the present invention;

FIG. 6 is a flowchart illustrating a procedure of a vehicle operation according to the first embodiment of the present invention;

FIGS. 7A and 7B are configuration diagrams illustrating a configuration of a two-way communication system according to a second embodiment of the present invention; and

FIG. 8 is an explanatory diagram illustrating an in-vehicle device and mobile phones according to Japanese Unexamined Patent Application Publication No. 2008-42577.

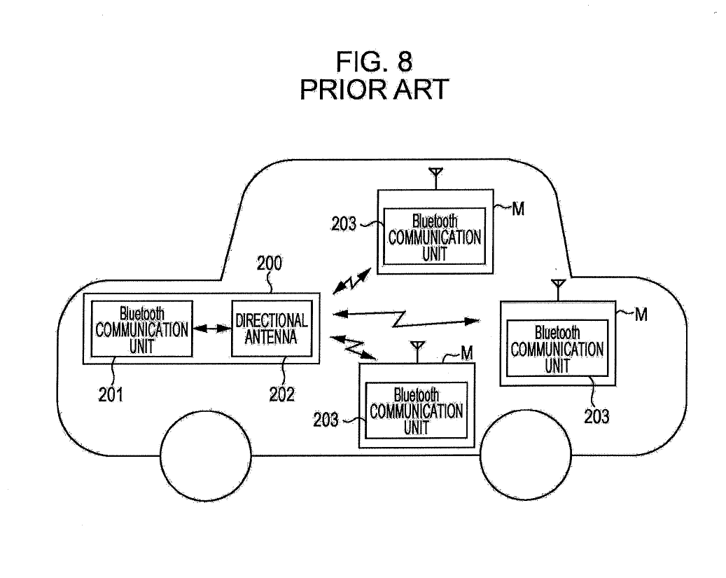

### DESCRIPTION OF THE EXEMPLARY EMBODIMENTS

Hereinafter, a first embodiment of the present invention will be described with reference to drawings. In addition, in the present embodiment, in order to easily understand the description, a two-way communication system including two in-vehicle communication units and two portable units will be described.

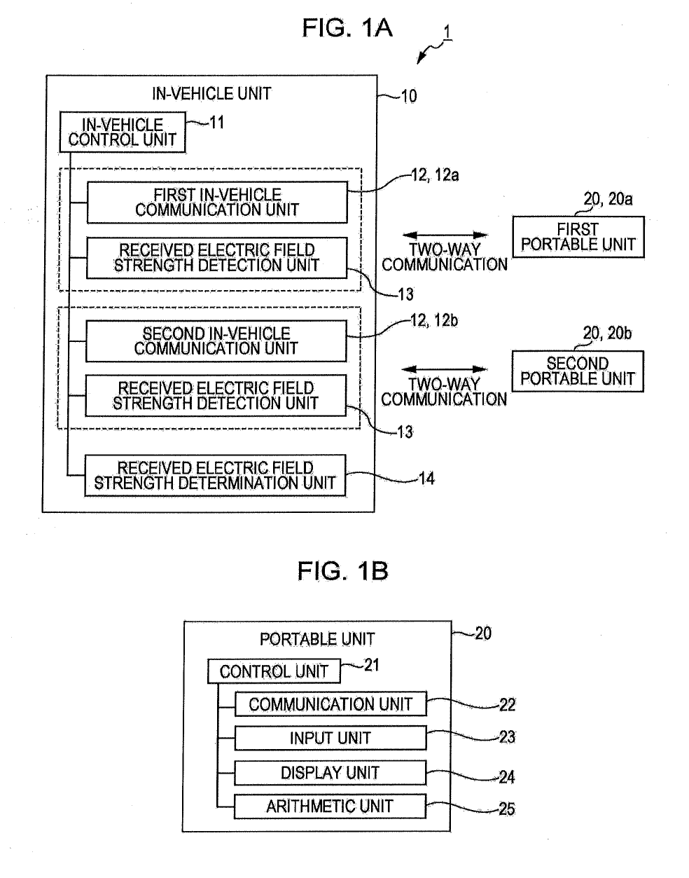

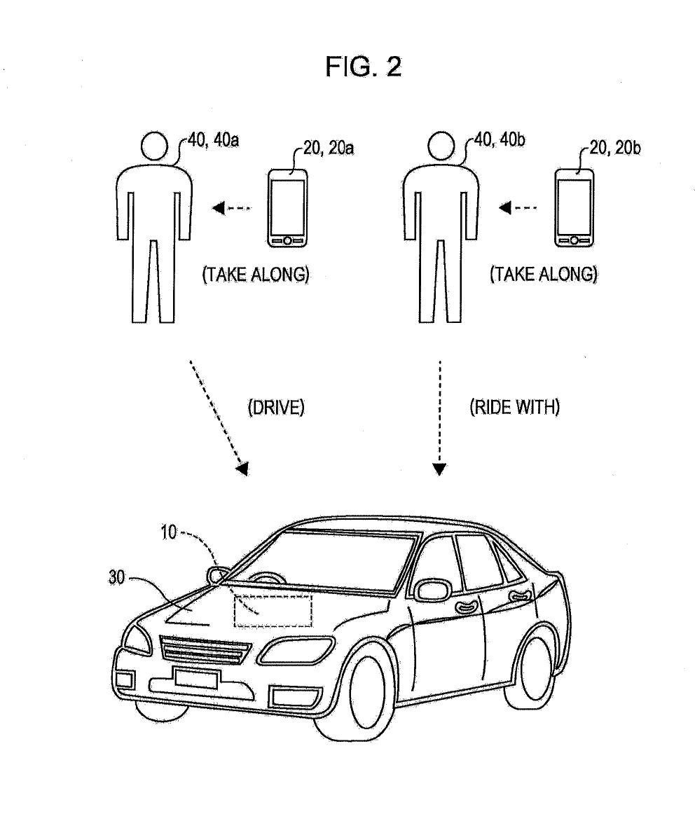

First, the configuration of a two-way communication system 1 according to the first embodiment of the present invention will be described with reference to FIGS. 1A and 1B and FIG. 2. FIGS. 1A and 1B are configuration diagrams illustrating the configuration of the two-way communication system 1 according to the first embodiment of the present invention. FIG. 1A is a configuration diagram illustrating the entire configuration, and FIG. 1B is a configuration diagram illustrating the configuration of each of portable units 20 illustrated in FIG. 1A. FIG. 2 is an explanatory diagram illustrating an example of use of the two-way communication system 1 illustrated in FIGS. 1A and 1B.

As illustrated in FIGS. 1A and 1B, the two-way communication system 1 includes an in-vehicle unit 10 and the two portable units 20. The in-vehicle unit 10 and the portable units 20 are able to perform two-way communication with each other. As illustrated in FIG. 2, the in-vehicle unit 10 is installed in a predetermined position in a vehicle 30. Two users 40 take along the respective two portable units 20.

Hereinafter, it is assumed that one of the two portable units 20 is a first portable unit 20a and the other thereof is a second portable unit 20b. In addition, it is assumed that one of the two users 40 is a first user 40a (driver) and the other thereof is a second user 40b (fellow passenger). In addition, it is assumed that the first user 40a drives the vehicle 30 while taking along the first portable unit 20a and the second user 40b rides in the vehicle 30 with the first user 40a while taking along the second portable unit 20b.

Next, the in-vehicle unit 10 will be described. As illustrated in FIGS. 1A and 1B, the in-vehicle unit 10 includes an in-vehicle control unit 11, two in-vehicle communication units 12, two received electric field strength detection units 13, and a received electric field strength determination unit 14. Hereinafter, it is assumed that one of the two in-vehicle communication units 12 is a first in-vehicle communication unit 12a and the other thereof is a second in-vehicle communication unit 12b. While not illustrated, the first in-vehicle communication unit 12a and the second in-vehicle communication unit 12b are spaced at a predetermined interval within the vehicle 30.

The in-vehicle communication unit 12 is a communication device compatible with a short distance wireless communication standard such as Bluetooth (registered trademark). The in-vehicle communication unit 12 is able to perform two-way communication utilizing an electromagnetic wave signal for short distance wireless communication. In addition, the electromagnetic wave signal for the short distance wireless communication is a weak electromagnetic wave signal, and a distance the electromagnetic wave signal reaches (hereinafter, abbreviated to a communication distance) is limited to about several meters.

The received electric field strength detection units 13 are embedded in the respective two in-vehicle communication units 12, and detect the received electric field strengths of electromagnetic wave signals received by the in-vehicle communication units 12 when the in-vehicle unit 10 and the portable units 20 perform two-way communication with each other. Based on the received electric field strengths detected by the received electric field strength detection units 13, the received electric field strength determination unit 14 determines whether or not the received electric field strengths are greater than or equal to a predetermined value.

The in-vehicle control unit 11 controls the in-vehicle communication units 12, the received electric field strength detection units 13, and the received electric field strength determination unit 14. In addition, the in-vehicle control unit 11 acquires various kinds of information from the in-vehicle communication units 12, the received electric field strength detection units 13, and the received electric field strength determination unit 14, and performs various kinds of determination, based on the acquired information. In addition, the in-vehicle control unit 11 is connected to various kinds of in-vehicle devices not illustrated, and issues an instruction relating to a vehicle operation, and acquires vehicle information.

Next, the portable units 20 will be described. As the portable units 20, personal digital assistants called smartphones are used. In addition, as illustrated in FIGS. 1A and 1B, the portable units 20 each include a control unit 21, a communication unit 22, an input unit 23, a display unit 24, and an arithmetic unit 25.

The communication unit 22 is a communication device embedded in the personal digital assistant and compatible with the short distance wireless communication standard such as Bluetooth. The communication unit 22 is able to perform two-way communication utilizing an electromagnetic wave signal for the short distance wireless communication. In addition, the electromagnetic wave signal for the short distance wireless communication is a weak electromagnetic wave signal, and a communication distance is limited to about several meters.

The input unit 23 detects an input operation by the user 40. As the input unit 23, an input device called a touch panel, or the like is used. The display unit 24 displays various kinds of information. As the display unit 24, a display device such as a liquid crystal panel is used. The arithmetic unit 25 performs various kinds of arithmetic operations. The control unit 21 controls the communication unit 22, the input unit 23, the display unit 24, and the arithmetic unit 25.

In addition, while not illustrated, the portable unit 20 further includes a communication unit other than the communication unit 22, which is able to perform wireless communication with a communication network, a rechargeable battery, a charging unit for charging the battery, and so forth.

Next, the two-way communication between the in-vehicle unit 10 and one of the portable units 20 will be described. In the two-way communication system 1, the two-way communication is able to be performed between the in-vehicle unit 10 and the portable unit 20. The two-way communication between the in-vehicle unit 10 and the portable unit 20 is performed using one of the in-vehicle communication units 12 in the in-vehicle unit 10 and the communication unit 22 in the portable unit 20. When the two-way communication between the in-vehicle unit 10 and the portable unit 20 is performed, a communication connection is performed between one of the in-vehicle communication units 12 in the in-vehicle unit 10 and the communication unit 22 in the portable unit 20.

Hereinafter, the two-way communication between one of the in-vehicle communication units 12 in the in-vehicle unit 10 and the communication unit 22 in the portable unit 20 is abbreviated to two-way communication between the in-vehicle communication unit 12 and the portable unit 20. In addition, the communication connection between one of the in-vehicle communication units 12 in the in-vehicle unit 10 and the communication unit 22 in the portable unit 20 is abbreviated to a communication connection between the in-vehicle communication unit 12 and the portable unit 20.

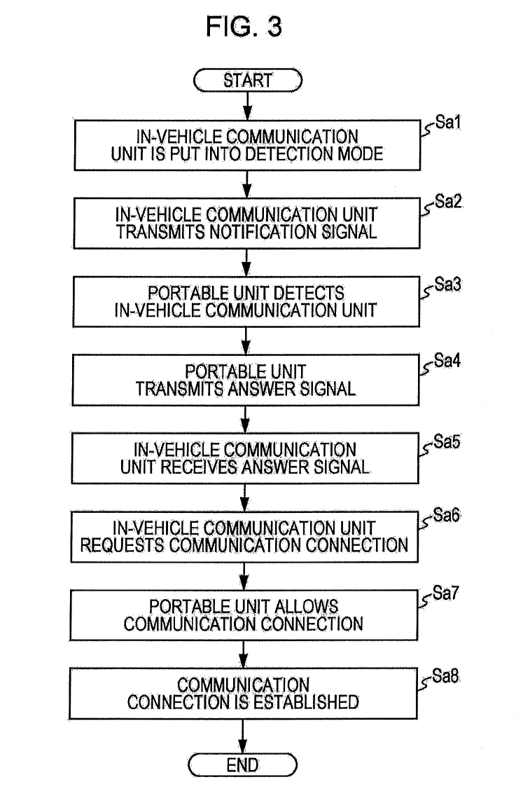

Next, the procedure of the communication connection between one of the in-vehicle communication units 12 and one of the portable units 20 will be described with reference to FIG. 3. FIG. 3 is a flowchart illustrating the procedure of a communication connection according to the first embodiment of the present invention.

It is desirable that the in-vehicle communication unit 12 is able to switch between a detection mode and a non-detection mode. In addition, in the detection mode, the in-vehicle communication unit 12 periodically transmits a notification signal informing that a communication connection is available, and in the non-detection mode, the in-vehicle communication unit 12 does not transmit the notification signal. By receiving the notification signal, the portable unit 20 detects the in-vehicle communication unit 12 with which a communication connection is able to be established. Therefore, in the detection mode, the in-vehicle communication unit 12 may be put into a state in which the portable unit 20 is able to detect the in-vehicle communication unit 12, and in the non-detection mode, the in-vehicle communication unit 12 may be put into a state in which the portable unit 20 is not able to detect the in-vehicle communication unit 12.

When the in-vehicle communication unit 12 and the portable unit 20 perform a communication connection with each other, first the in-vehicle communication unit 12 serving as a target of a communication connection may be put into the detection mode, as illustrated in FIG. 3 (step Sa1). In addition, the in-vehicle communication unit 12 transmits the notification signal (step Sa2). Next, the portable unit 20 searches for the in-vehicle communication units 12, and detects one of the in-vehicle communication units 12 with which a communication connection is able to established (step Sa3). In addition, the portable unit 20 transmits an answer signal corresponding to the notification signal (step Sa4). The answer signal includes ID information used for identifying whether the portable unit 20 is the first portable unit 20a or the second portable unit 20b.

Next, the in-vehicle communication unit 12 receives the answer signal (step Sa5). Next, the in-vehicle communication unit 12 performs matching, based on the ID information included in the answer signal, and in a case where the answer signal is a signal from the portable unit 20 serving as a target of a communication connection, the in-vehicle communication unit 12 requests that portable unit 20 to establish a communication connection (step Sa6). In addition, the portable unit 20 allows the communication connection (step Sa7), and the communication connection between the in-vehicle communication unit 12 and the portable unit 20 is established (step Sa8). In the two-way communication system 1, in accordance with such a procedure, the communication connection between the in-vehicle communication unit 12 and the portable unit 20 is performed.

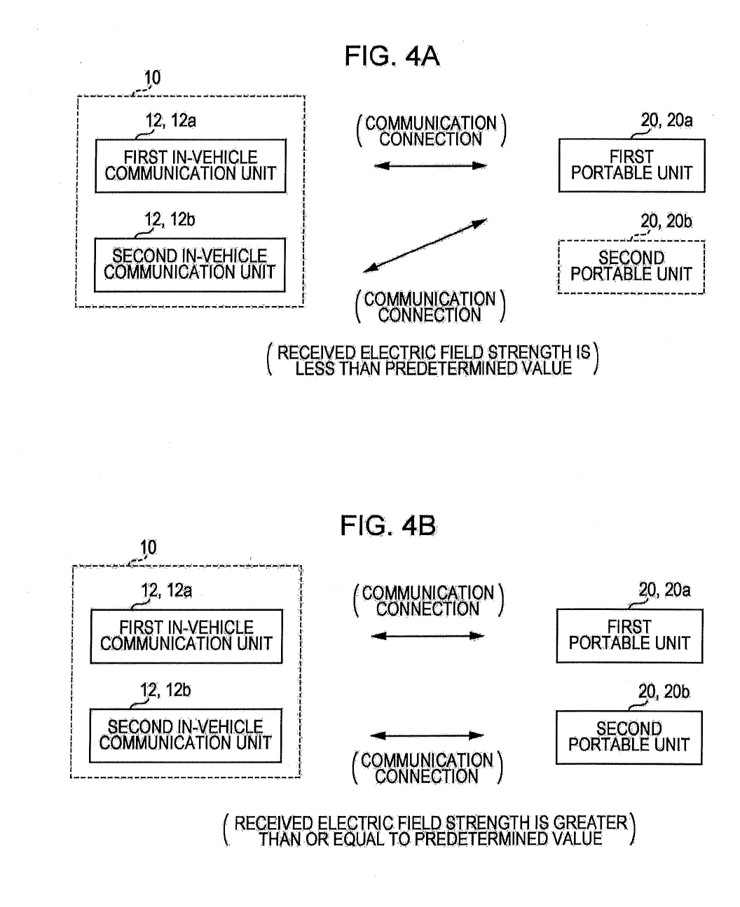

Next, a specific example of communication connections when the communication connections are performed between the two in-vehicle communication units 12 and the two portable units 20 will be described. First, selective communication connections between the two in-vehicle communication units 12 and the two portable units 20, based on received electric field strength, will be described with reference to FIGS. 4A and 4B. FIGS. 4A and 4B are first explanatory diagrams illustrating specific examples of communication connections according to the first embodiment of the present invention. FIG. 4A is an explanatory diagram in a case where the received electric field strength is less than a predetermined value, and FIG. 4B is an explanatory diagram in a case where the received electric field strength is greater than or equal to the predetermined value.

In the two-way communication system 1, as illustrated in FIGS. 4A and 4B, first, regardless of whether or not the received electric field strength is greater than or equal to the predetermined value, the first in-vehicle communication unit 12a and the first portable unit 20a are communication-connected to each other. After that, based on received electric field strength in two-way communication between the first in-vehicle communication unit 12a and the first portable unit 20a, selective communication connections are performed between the second in-vehicle communication unit 12b and the first portable unit 20a and second portable unit 20b.

In a case where the received electric field strength is less than the predetermined value, the second in-vehicle communication unit 12b is communication-connected to the first portable unit 20a, as illustrated in FIG. 4A. As a result, the first in-vehicle communication unit 12a and the first portable unit 20a are communication-connected to each other, and the second in-vehicle communication unit 12b and the first portable unit 20a are communication-connected to each other. In this way, in a case where the received electric field strength is less than the predetermined value, the two in-vehicle communication units 12 and one of the portable units 20 are communication-connected to each other. The two in-vehicle communication units 12 are spaced at the predetermined interval, as described above. Therefore, the two-way communication utilizing the space diversity effect becomes available between the two in-vehicle communication units 12 and one of the portable units 20. In addition, the second portable unit 20b is not communication-connected to the first in-vehicle communication unit 12a or the second in-vehicle communication unit 12b.

On the other hand, in a case where the received electric field strength is greater than or equal to the predetermined value, the second in-vehicle communication unit 12b is communication-connected to the second portable unit 20b, as illustrated in FIG. 4B. As a result, the first in-vehicle communication unit 12a and the first portable unit 20a are communication-connected to each other, and the second in-vehicle communication unit 12b and the second portable unit 20b are communication-connected to each other. In this way, in a case where the received electric field strength is greater than or equal to the predetermined value, the two in-vehicle communication units 12 and the respective two portable units 20 are communication-connected to each other on a one-to-one basis. In addition, it becomes possible for the two in-vehicle communication units 12 to simultaneously receive two kinds of signals simultaneously transmitted from the respective two portable units 20.

The detection of the received electric field strength is performed by the received electric field strength detection unit 13. After the first in-vehicle communication unit 12a and the first portable unit 20a are communication-connected to each other, the received electric field strength detection unit 13 detects the received electric field strength of a signal received from the first portable unit 20a by the first in-vehicle communication unit 12a. In addition, the received electric field strength determination unit 14 determines whether or not the received electric field strength is greater than or equal to the predetermined value, and the in-vehicle control unit 11 determines one of the portable units 20, which is to be communication-connected to the in-vehicle communication unit 12.

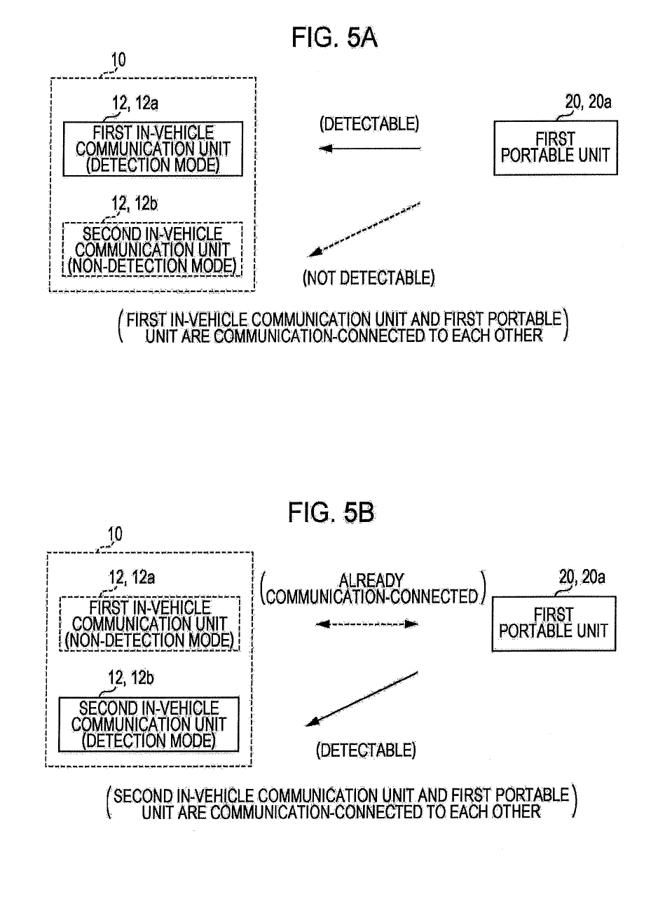

Next, a communication connection in a case where the two in-vehicle communication units 12 and one of the portable units 20 perform communication connections with each other will be described with reference to FIGS. 5A and 5B. FIGS. 5A and 5B are second explanatory diagrams illustrating specific examples of communication connections according to the first embodiment of the present invention. FIGS. 5A and 5B illustrate an example of a case where, first, the first in-vehicle communication unit 12a and the first portable unit 20a perform a communication connection with each other and after that, the second in-vehicle communication unit 12b and the first portable unit 20a perform a communication connection with each other. FIG. 5A is an explanatory diagram in a case where the first in-vehicle communication unit 12a and the first portable unit 20a perform a communication connection with each other, and FIG. 5B is an explanatory diagram in a case where, after that, the second in-vehicle communication unit 12b and the first portable unit 20a perform a communication connection with each other.

First, in a case where the first in-vehicle communication unit 12a and the first portable unit 20a perform a communication connection with each other, the first in-vehicle communication unit 12a may be put into the detection mode and the second in-vehicle communication unit 12b may be put into the non-detection mode, as illustrated in FIG. 5A. In addition, the first portable unit 20a detects the first in-vehicle communication unit 12a, and a communication connection between the first in-vehicle communication unit 12a and the first portable unit 20a is established. The second in-vehicle communication unit 12b is in the non-detection mode, and even if the first portable unit 20a searches for the corresponding in-vehicle communication unit 12, it may be difficult to detect the second in-vehicle communication unit 12b.

Next, in a case where the second in-vehicle communication unit 12b and the first portable unit 20a perform a communication connection with each other, the first in-vehicle communication unit 12a where the communication connection is established may switch from the detection mode to the non-detection mode, as illustrated in FIG. 5B. In addition, the second in-vehicle communication unit 12b may switch from the non-detection mode to the detection mode. In addition, the first portable unit 20a detects the second in-vehicle communication unit 12b, and a communication connection between the second in-vehicle communication unit 12b and the first portable unit 20a is established.

In the two-way communication system 1, in this way, when the two in-vehicle communication units 12 and one of the portable units 20 perform communication connections with each other, one in-vehicle communication unit 12 out of the two in-vehicle communication units 12 may be put into the detection mode, and the other in-vehicle communication unit 12 may be put into the non-detection mode. Therefore, the number of the in-vehicle communication units 12 detectable by the portable unit 20 is constantly one.

In addition, while the description of other combinations of communication connections is omitted, one in-vehicle communication unit 12 out of the two in-vehicle communication units 12 may be put into the detection mode and the other in-vehicle communication unit 12 may be put into the non-detection mode, in the same way as in a case of the above-mentioned communication connections. Accordingly, it is possible to smoothly perform communication connections between the in-vehicle communication units 12 and the portable units 20.

The determination of the in-vehicle communication unit 12 and the portable unit 20 that are to serve as targets of a communication connection is performed by the in-vehicle control unit 11. In addition, switching between the detection mode and the non-detection mode is performed by the in-vehicle control unit 11.

Next, a vehicle operation utilizing the two-way communication system 1 will be described. In the present embodiment, using the two-way communication system 1, it is possible to perform various kinds of vehicle operations on the vehicle 30. The vehicle operations utilizing the two-way communication system 1 include vehicle operations such as locking and unlocking of a door, starting and stopping of an engine, opening and closing of a window, and an operation of an air conditioner. In addition, the vehicle operations utilizing the two-way communication system 1 further include confirmation of pieces of vehicle information relating to the vehicle 30 such as location information of the vehicle 30, remaining amount information of fuel, and the information of air pressure in a tire.

One of the users 40 performs predetermined input operations on the input unit 23 in the corresponding portable unit 20, and hence, the vehicle operations utilizing the two-way communication system 1 are executed. In addition, in a case where the two in-vehicle communication units 12 and the two portable units 20 are communication-connected to each other on a one-to-one basis, the two users 40 simultaneously operate the respective two portable units 20, and hence, it is possible to simultaneously perform two vehicle operations. In addition, which portable unit 20 of the two portable units 20 is caused to perform which of the vehicle operations is arbitrarily set in accordance with the specification or the like of the system.

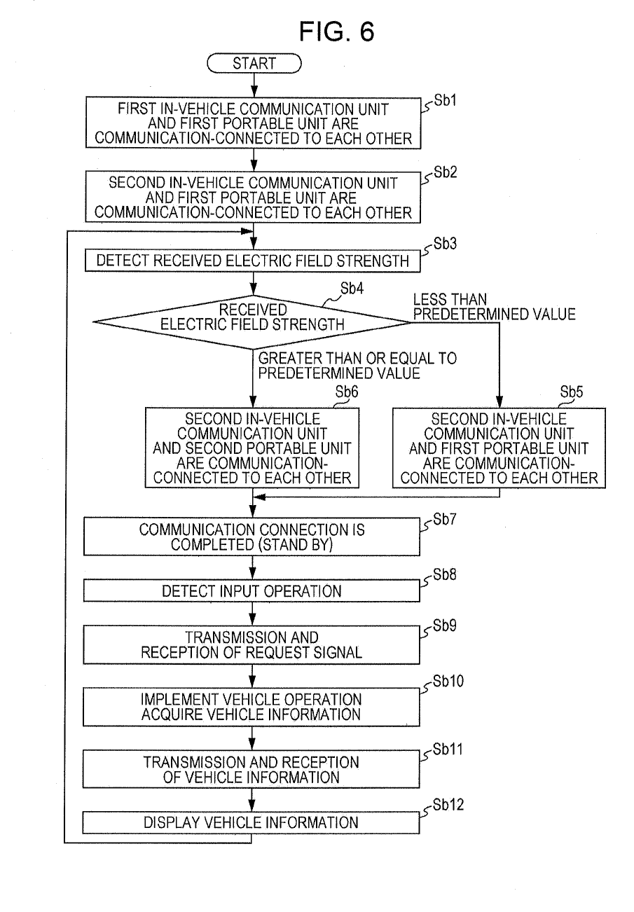

Next, the procedure of a vehicle operation utilizing the two-way communication system 1 will be described with reference to FIG. 6. FIG. 6 is a flowchart illustrating the procedure of a vehicle operation according to the first embodiment of the present invention. In addition, it is assumed that the vehicle operation performed in FIG. 6 is an operation including the confirmation of the vehicle information, and the description thereof is advanced.

As illustrated in FIG. 6, first, the first in-vehicle communication unit 12a and the first portable unit 20a are communication-connected to each other (step Sb1). Next, the second in-vehicle communication unit 12b and the first portable unit 20a are communication-connected to each other (step Sb2). Next, the received electric field strength detection unit 13 detects the received electric field strength (step Sb3). In addition, the received electric field strength determination unit 14 determines whether or not the received electric field strength is greater than or equal to the predetermined value, and the in-vehicle control unit 11 performs determination relating to a communication connection (step Sb4).

In a case where, in the step Sb4, the received electric field strength is less than the predetermined value, the communication connection between the second in-vehicle communication unit 12b and the first portable unit 20a is maintained (step Sb5). As a result, the first in-vehicle communication unit 12a and the first portable unit 20a are communication-connected to each other, and the second in-vehicle communication unit 12b and the first portable unit 20a are communication-connected to each other. In addition, the procedure moves to a step Sb7.

In a case where, in the step Sb4, the received electric field strength is greater than or equal to the predetermined value, the communication connection between the second in-vehicle communication unit 12b and the first portable unit 20a is terminated, and after that, the second in-vehicle communication unit 12b and the second portable unit 20b are communication-connected to each other (step Sb6). As a result, the first in-vehicle communication unit 12a and the first portable unit 20a are communication-connected to each other, and the second in-vehicle communication unit 12b and the second portable unit 20b are communication-connected to each other. In addition, the procedure moves to the step Sb7.

Next, in the step Sb7, the communication connection between the in-vehicle communication unit 12 and the portable unit 20 is completed, and the in-vehicle unit 10 and the portable unit 20 stand by in states of being capable of performing the two-way communication. Next, the input unit 23 in the portable unit 20 detects an input operation by the user 40 (step Sb8). Next, the communication unit 22 in the portable unit 20 transmits a request signal corresponding to the input operation, to the in-vehicle communication unit 12 in the in-vehicle unit 10 (step Sb9). Next, by issuing an instruction corresponding to the request signal, the in-vehicle control unit 11 in the in-vehicle unit 10 causes a predetermined vehicle operation to be performed, and acquires predetermined vehicle information (step Sb10).

Next, the in-vehicle communication unit 12 in the in-vehicle unit 10 transmits, to the portable unit 20, the vehicle information acquired by the in-vehicle control unit 11 in the in-vehicle unit 10 (step Sb11). Next, the arithmetic unit 25 in the portable unit 20 converts the vehicle information received by the portable unit 20, into a displayable form, and the display unit 24 displays the vehicle information (step Sb12).

After that, returning to the step Sb3, the received electric field strength detection unit 13 detects the received electric field strength again, and switches the communication connection between the in-vehicle communication unit 12 and the portable unit 20 as appropriate. In the two-way communication system 1, the vehicle operation is performed in this way.

In addition, since, in the two-way communication system 1, the in-vehicle communication unit 12 and the portable unit 20 perform the two-way communication with each other using the short distance wireless communication, the received electric field strength is reduced if the user 40 moves about several meters away from the vehicle 30. In addition, in a case where the received electric field strength is reduced and becomes less than the predetermined value, the two in-vehicle communication units 12 and one of the portable units 20 are communication-connected to each other as described above, and the two-way communication utilizing the space diversity effect becomes available between the two in-vehicle communication units 12 and one of the portable units 20. As a result, even in a case where the received electric field strength is reduced, it becomes possible to stabilize the communication.

On the other hand, if the two users 40 ride in the vehicle 30 and distances between the in-vehicle communication unit 12 and the portable units 20 become sufficiently small, the received electric field strength becomes high. In addition, in a case where the received electric field strength becomes high and greater than or equal to the predetermined value, the two in-vehicle communication units 12 and the two portable units 20 are communication-connected to each other on a one-to-one basis, and it becomes possible for the two in-vehicle communication units 12 to simultaneously receive two kinds of signals simultaneously transmitted from the respective two portable units 20. As a result, it becomes possible for the two users 40 to simultaneously perform a plurality of vehicle operations using the respective two portable units 20.

Next, advantageous effects of the present embodiment will be described. The two-way communication system 1 of the present embodiment includes the in-vehicle unit 10 installed in the vehicle 30, and the two portable units 20 capable of performing two-way communication with the in-vehicle unit 10. In addition, the in-vehicle unit 10 includes the two in-vehicle communication units 12 that perform two-way communication with the portable units 20, and the in-vehicle control unit 11 that controls communication connections between the two in-vehicle communication units 12 and the two portable units 20. Therefore, in the two-way communication system 1, it is possible to perform selective communication connections between the two in-vehicle communication units 12 and the two portable units 20. In addition, it is possible to stabilize communication using the space diversity effect while causing the two in-vehicle communication units 12 and one of the portable units 20 to be communication-connected to each other, and it is possible to simultaneously perform a plurality of vehicle operations while causing the two in-vehicle communication units 12 and the two portable units 20 to be communication-connected to each other on a one-to-one basis.

Furthermore, in the two-way communication system 1 of the present embodiment, the in-vehicle unit 10 includes the received electric field strength detection unit 13 that detects received electric field strength in the two-way communication between the in-vehicle unit 10 and the portable units 20, and the received electric field strength determination unit 14 that performs determination, based on the received electric field strength. In addition, based on the received electric field strength, communication connections between the two in-vehicle communication units 12 and the two portable units 20 are switched, and the two in-vehicle communication units 12 and one of the portable units 20 are communication-connected to each other, or the two in-vehicle communication units 12 and the two portable units 20 are communication-connected to each other on a one-to-one basis. Therefore, it is possible to cause the in-vehicle communication units 12 for obtaining the space diversity effect to double as the in-vehicle communication units 12 for performing the two-way communication with the two portable units 20 on a one-to-one basis. As a result, it is possible to reduce the number of the in-vehicle communication units 12 and to simplify the configuration of the system.

In addition, in the two-way communication system 1 of the present embodiment, a function for stabilizing communication while causing the two in-vehicle communication units 12 and one of the portable units 20 to be communication-connected to each other is usually used in, for example, a case where the first user 40a locks or unlocks a door at a point distant from the vehicle 30. Since, in such a situation, vehicle operations performed by the user 40 are restricted, a function for simultaneously performing a plurality of vehicle operations becomes unnecessary. On the other hand, a function for simultaneously performing a plurality of vehicle operations while causing the two in-vehicle communication units 12 and the two portable units 20 to be communication-connected to each other on a one-to-one basis is usually used in, for example, a case where the two users 40 ride in the vehicle 30 and perform various kinds of vehicle operations inside the vehicle. Since, in such a situation, distances between the in-vehicle communication unit 12 and the portable units 20 become sufficiently small and a communication state becomes favorable, the function for stabilizing communication while causing the two in-vehicle communication units 12 and one of the portable units 20 to be communication-connected to each other becomes unnecessary. Therefore, in the two-way communication system 1 of the present embodiment, it is possible to switch communication connections between the two in-vehicle communication units 12 and the two portable units 20 without lowering convenience in the vehicle operations.

In addition, in the two-way communication system 1 of the present embodiment, in a case where the two in-vehicle communication units 12 are in states of being able to be simultaneously detected when, for example, one of the portable units 20 performs communication connections with the two in-vehicle communication units 12, it is necessary for one of the users 40 to manually select which of the two in-vehicle communication units 12 the portable unit 20 is to be communication-connected to. As a result, a burden occurs when a communication connection between the in-vehicle communication unit 12 and the portable unit 20 is performed.

However, in the two-way communication system 1 of the present embodiment, it is desirable that the in-vehicle communication unit 12 is able to switch between the detection mode of being able to be detected by the portable unit 20 and the non-detection mode of being unable to be detected by the portable unit 20. In addition, when one of the portable units 20 performs communication connections with the two in-vehicle communication units 12, one in-vehicle communication unit 12 may be put into the detection mode, and the other in-vehicle communication unit 12 may be put into the non-detection mode. Therefore, the number of the in-vehicle communication units 12 detectable by the portable unit 20 is constantly one. In such a case, it becomes unnecessary for one of the users 40 to select which of the two in-vehicle communication units 12 the portable unit 20 is to be communication-connected to. In addition, it is possible to cause the portable unit 20 to automatically perform a communication connection with the detected one of the in-vehicle communication units 12. As a result, it is possible to smoothly perform communication connections between the in-vehicle communication units 12 and the portable units 20.

In addition, in a second embodiment, in a case of adopting the same configuration as that in the first embodiment, the same symbol is assigned thereto, and the description thereof will be omitted.

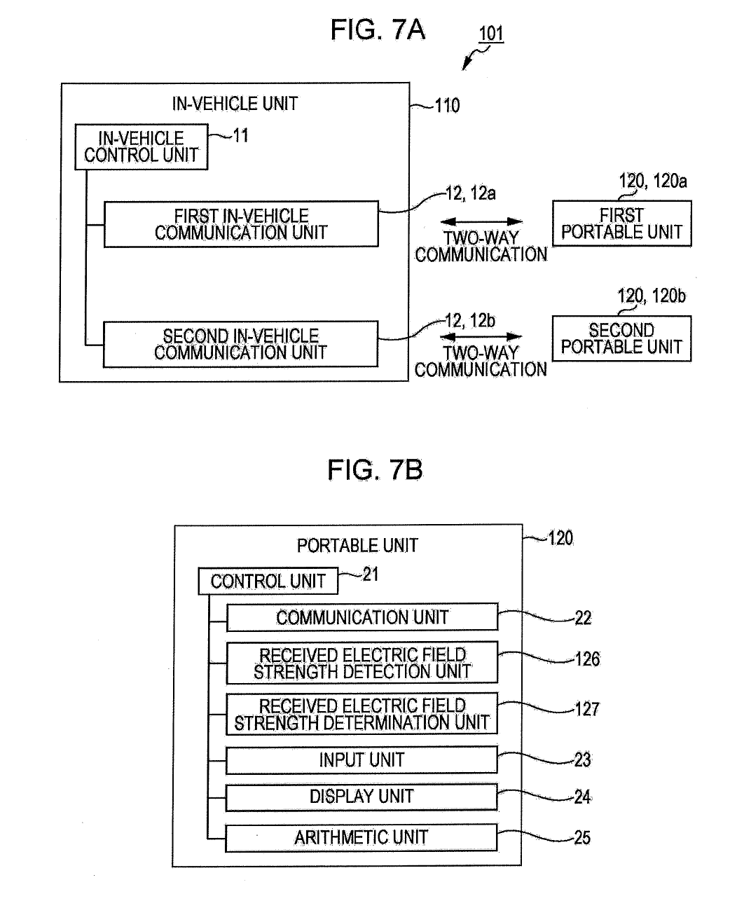

First, the configuration of a two-way communication system 101 according to the second embodiment of the present invention will be described with reference to FIGS. 7A and 7B. FIGS. 7A and 7B are configuration diagrams illustrating the configuration of the two-way communication system 101 according to the second embodiment of the present invention. FIG. 7A is a configuration diagram illustrating the entire configuration, and FIG. 7B is a configuration diagram illustrating the configuration of one of portable units 120 illustrated in FIG. 7A.

As illustrated in FIGS. 7A and 7B, the two-way communication system 101 includes an in-vehicle unit 110 and the two portable units 120. One of the two portable units 120 is a first portable unit 120a and the other thereof is a second portable unit 120b. In this way, in the two-way communication system 101, the in-vehicle unit 10 and the portable units 20 in the two-way communication system 1 according to the first embodiment are replaced with the corresponding in-vehicle unit 110 and the respective portable units 120. In addition, the first portable unit 20a and the second portable unit 20b are replaced with the first portable unit 120a and the second portable unit 120b, respectively.

The in-vehicle unit 110 includes the in-vehicle control unit 11 and the two in-vehicle communication units 12. The portable unit 120 includes the control unit 21, the communication unit 22, the input unit 23, the display unit 24, the arithmetic unit 25, a received electric field strength detection unit 126, and a received electric field strength determination unit 127. In this way, in the two-way communication system 101, the received electric field strength detection unit 126 and the received electric field strength determination unit 127 are included not in the in-vehicle unit 110 but in each of the portable units 120.

In the present embodiment, the received electric field strength detection unit 126 detects received electric field strength when the in-vehicle unit 110 and the corresponding portable unit 120 perform two-way communication with each other. In addition, based on the received electric field strength detected by the received electric field strength detection unit 126, the received electric field strength determination unit 127 determines whether or not the received electric field strength is greater than or equal to a predetermined value. The result of the determination performed by the received electric field strength determination unit 127 is transmitted to an in-vehicle unit 110 side, using the two-way communication performed between the in-vehicle unit 110 and the corresponding portable unit 120. In addition, on the basis of the transmitted determination result, the in-vehicle control unit 11 determines one of the in-vehicle communication units 12 and one of the portable units 120, which are to serve as communication targets.

In the two-way communication system 101, a selective communication connection is performed in this way. In addition, in the present embodiment, the same advantageous effects as those of the first embodiment are obtained.

While, as above, the embodiments of the present invention have been described, the present invention is not limited to the above-mentioned embodiments, and may be arbitrarily altered without departing from the scope of an object of the present invention.

For example, in one of the embodiments of the present invention, one user 40 may simultaneously perform a plurality of vehicle operations using the two portable units 20 (or the two portable units 120). In addition, the first user 40a may take along the second portable unit 20b, and the second user 40b may take along the first portable unit 20a. In that case, a setting of which portable unit 20 of the two portable units 20 is caused to perform which of vehicle operations may be arbitrarily changed.

In addition, in one of the embodiments of the present invention, the number of the in-vehicle communication units 12 may be three or more. In addition, the number of the portable units 20 (or the portable units 120) may be three or more. In addition, the in-vehicle unit 10 (or the in-vehicle unit 110) and these portable units 20 (or the portable units 120) may be communication-connected to each other on a one-to-one basis, and more vehicle operations may be simultaneously performed. In addition, by arranging more in-vehicle communication units 12 in the vehicle 30, the space diversity effect may be further enhanced. In addition, in a case where the number of the portable unit 20 (or the portable units 120) is fewer than the number of the in-vehicle communication units 12, even if the received electric field strength is greater than or equal to the predetermined value, it is not necessary for all the in-vehicle communication units 12 to be communication-connected to the portable units 20 (or the portable units 120).

In addition, in one of the embodiments of the present invention, the in-vehicle communication units 12 in the in-vehicle unit 10 and the communication units 22 in the portable units 20 (or the portable units 120) may be communication devices compatible with a communication standard other than Bluetooth. In recent years, for example, a communication device compatible with a communication standard that is called Bluetooth low energy and in which electric power necessary for communication is further reduced has been put into practical use. Using such a communication device, it is possible to suppress power consumption when the in-vehicle communication units 12 and the portable units 20 (or the portable units 120) perform two-way communication with each other. In addition, the in-vehicle communication units 12 in the in-vehicle unit 10 and the communication units 22 in the portable units 20 (or the portable units 120) may be communication devices compatible with a communication method other than the short distance wireless communication.

In addition, in one of the embodiments of the present invention, the two in-vehicle communication units 12 in the in-vehicle unit 10 (or the in-vehicle unit 110) may each include a main body unit and an antenna unit, the two antenna units may be spaced at a predetermined interval, and the two main body units may be arranged together in one point.

In addition, in the first embodiment of the present invention, the portable units 20 may each include one of the received electric field strength detection unit 13 and the received electric field strength determination unit 14. In addition, in the second embodiment of the present invention, the in-vehicle unit 10 may include one of the received electric field strength detection unit 126 and the received electric field strength determination unit 127.

In addition, in one of the embodiments of the present invention, the communication connection utilizing switching between the detection mode and the non-detection mode of the in-vehicle communication unit 12 may be performed in a case other than a case where the two in-vehicle communication units 12 and one of the portable units 20 perform communication connections with each other. Even in a case where, by performing a setting so that the in-vehicle communication units 12 each select and transmit, for example, a first notification signal detectable by only the first portable unit 20a and a second notification signal detectable by only the second portable unit 20b, the two in-vehicle communication units 12 and the two portable units 20 perform communication connections with each other, the communication connection utilizing switching between the detection mode and the non-detection mode of the in-vehicle communication unit 12 may become available. In addition, in addition to a case where the two in-vehicle communication units 12 and one of the portable units 20 perform communication connections used for performing a vehicle operation, the communication connection utilizing switching between the detection mode and the non-detection mode of the in-vehicle communication unit 12 may be performed in a case where the two in-vehicle communication units 12 and one of the portable units 20 perform communication connections used for authentication and registration.

What is claimed is:

1. A two-way communication system comprising:
an in-vehicle unit installed in a vehicle; and
a plurality of portable units that perform two-way communication with the in-vehicle unit, wherein
the in-vehicle unit includes
a plurality of in-vehicle communication units configured to perform two-way communication with the portable units, and
an in-vehicle control unit configured to control communication connections between the in-vehicle communication units and the portable units, and
one of the in-vehicle unit or the portable units each include:
a received electric field strength detection unit configured to detect received electric field strength in the two-way communication between the in-vehicle unit and the portable units, and
a received electric field strength determination unit configured to perform determination, based on the received electric field strength, wherein
in a case where the received electric field strength is less than a predetermined value,
the plural in-vehicle communication units and one of the portable units are communication-connected to each other, and
in a case where the received electric field strength is greater than or equal to the predetermined value,
the plural in-vehicle communication units and the plural portable units are communication-connected to each other on a one-to-one basis.

2. The two-way communication system according to claim 1, wherein:
each of the in-vehicle communication units is able to switch between;
a detection mode of being able to be detected by the portable units; and
a non-detection mode of being unable to be detected by the portable units, wherein:
when the portable units perform communication connections with the plural in-vehicle communication units,
one in-vehicle communication unit out of the plural in-vehicle communication units is put into the detection mode, and
other in-vehicle communication units are put into the non-detection mode, and
after the portable units are communication-connected to the one in-vehicle communication unit,
another in-vehicle communication unit out of the plural in-vehicle communication units is put into the detection mode, and
other in-vehicle communication units are put into the non-detection mode.
